(19) United States
(12) Patent Application Publication
(10) Pub. No.: US 2008/0205349 A1
(43) Pub. Date: Aug. 28, 2008

(54) APPARATUS AND METHOD FOR ENCODING AND DECODING CONTROL INFORMATION IN A MOBILE COMMUNICATION SYSTEM SUPPORTING HIGH-SPEED PACKET DATA TRANSMISSION

(75) Inventors: Oh-Seok KIM, Seoul (KR); Young-Bum Kim, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/036,583

(22) Filed: Feb. 25, 2008

(30) Foreign Application Priority Data
Feb. 23, 2007 (KR) 18416-2007

(51) Int. Cl. H04B 7/216

(52) U.S. Cl. 370/335

(57) ABSTRACT

A method for encoding a control channel to transmit high-speed packet data in a base station of a high-speed packet data communication system. The method includes encoding a User Equipment Identifier (UE ID) of a UE that will receive the high-speed packet data, and rate-matching the encoded UE ID to generate a first stream; generating an offset value for cyclic-shifting the first stream, using the UE ID; encoding control information that the UE needs to receive the high-speed packet data, and rate-matching the encoded control information to generate a second stream; cyclic-shifting each of the first stream and the second stream by the offset value; and masking the cyclic-shifted second stream with the cyclic-shifted stream before transmission.

### PRIORITY

This application claims priority under 35 U.S.C. § 119(a) to a Korean Patent Application filed in the Korean Intellectual Property Office on Feb. 23, 2007 and assigned Serial No. 2007-18416, the disclosure of which is hereby incorporated by reference.

### BACKGROUND OF THE INVENTION

1. Field of the Invention

The present invention generally relates to an apparatus and method for transmitting and receiving a control channel in a mobile communication system supporting high-speed packet data transmission, and in particular, to an apparatus and method for encoding and decoding a High Speed-Shared Control Channel (HS-SCCH) for supporting High Speed Downlink Packet Access (HSDPA) in a Wideband Code Division Multiple Access (WCDMA) mobile communication system.

2. Description of the Related Art

Mobile communication systems are evolving into high-speed, high-quality wireless data packet communication systems for providing data services and multimedia services beyond the early voice-oriented services. Standardization for HSDPA and CDMA 2000 1× Evolution Data and Voice (EV-DV), now being led by 3^{rd} Generation Partnership Project (3GPP) and 3GPP2, can be considered as the typical effort to find a solution for high-speed, high-quality wireless data packet transmission services of 2 Mbps (Megabits per second) or higher in the 3^{rd} generation mobile communication system, and the 4^{th} generation mobile communication system aims to provide higher-speed, higher-quality multimedia services.

A description will be given of HSDPA, one of the services supporting the high-speed packet data transmission, which has been proposed by 3GPP.

HSDPA is a system for high-speed downlink packet data services available in the same frequency bands as those of the existing WCDMA Release 99 and Release 4. HSDPA employs Adaptive Modulation and Coding (AMC) and Hybrid Automatic Repeat reQuest (H-ARQ) techniques for an increase in the transmission efficiency, and adds a scheduler function to the Node B to achieve fast channel adaptation.

AMC is a link adaptation technique for determining (selecting) the most appropriate one of predefined Modulation and Coding Selection (MCS) levels according to the change in the channel environment. In HSDPA, modulation schemes of Quadrature Phase Shift Keying (QPSK) and 16-ary Quadrature Amplitude Modulation (16QAM) are used for an efficient AMC operation, and a rate-⅓ turbo code is efficiently punctured to obtain various MCS levels. In addition, to deliver the quality information of the channel to a transmission side, a reception side transmits a Channel Quality Indicator (CQI) over the uplink.

H-ARQ, a combined technology of an ARQ-based error control technique for a Medium Access Control (MAC) layer and a channel coding-based error control technique for a physical layer, is a technology for increasing the system capacity by reducing the number of retransmissions.

In HSDPA, downlinks and uplinks are added within the scope of not affecting the existing WCDMA system in order to enable downlink high-speed packet data transmission, and the added links are as follows.

A High Speed Downlink Shared Channel (HS-DSCH) is a downlink transmission channel for high-speed packet data transmission. An HS-DSCH can transmit data over more than one HS-PDSCH.

A High Speed Physical Downlink Shared Channel (HS-PDSCH) is a downlink physical channel used for transmitting HS-DSCH data. Each base station can manage a maximum of 15 HS-PDSCHs.

A High Speed Shared Control Channel (HS-SCCH) is a downlink channel used for transmitting, by a base station, control information necessary for receiving, by a terminal, packet data transmitted over an HS-DSCH, and control information for other purposes.

A High Speed Dedicated Physical Control Channel (HS-DPCCH) is an uplink channel used for selecting, by each terminal, a base station having the best downlink pilot channel condition, and feeding back modulation and coding information appropriate for the corresponding channel condition. Upon receiving packet data from the base station, the terminal transmits Acknowledgement/Non-Acknowledgement (ACK/NACK) information over an HS-DPCCH.

As described above, for reception of a high-speed packet, HSDPA adds a new shared control channel HS-SCCH to transmit control information for demodulation of an HS-PDSCH over which packet data is transmitted. That is, an HS-PDSCH cannot be normally demodulated until reception of an HS-SCCH is normally completed.

FIG. 1 is a diagram illustrating a timing relationship between an HS-SCCH 110 and an HS-PDSCH 120 in an HSDPA system.

As shown in FIG. 1, HS-SCCH 110 is transmitted two slots earlier than HS-PDSCH 120, and carries control information for demodulation of HS-PDSCH 120. Therefore, a mobile terminal, or User Equipment (UE), demodulates HS-SCCH 110, and then demodulates HS-PDSCH 120, which is transmitted 2 slots later than HS-SCCH 110, using the control information obtained through the demodulation of HS-SCCH 110.

FIG. 2 is a diagram illustrating a subframe structure of the HS-SCCH 110 in an HSDPA system.

HS-SCCH 110, a downlink control channel using QPSK and Spreading Factor (SF)=128 added for HSDPA service, includes information for reception of a major traffic channel HS-PDSCH 120 over which data is transmitted as described above. HS-SCCH 110 is commonly composed of a 1-slot part #1 200a and a 2-slot part #2 200b. The part #1 200a carries Modulation Scheme (MS) and Channelization Code Set (CCS), and the part #2 200b carries H-ARQ-related information such as Transport Block size information, H-ARQ Process information (HAP), Redundancy and Constellation Version (RV), New data Indicator (NI), etc.

That is, the part #1 200a uses UE Identifier (ID) specific masking generated with UE ID, thereby providing an effect of transmitting UE ID indirectly, and the part #2 200b uses UE specific Cyclic Redundancy Check (CRC) based on UE ID, thereby providing an effect of transmitting UE ID indirectly.

A UE determines through demodulation of HS-SCCH 110 whether a data packet carried on HS-PDSCH 120, which is transmitted two slots after HS-SCCH 110, is a packet delivered to the UE itself. That is, if it is determined that the demodulation result of HS-SCCH 110 is reliable, the UE demodulates HS-PDSCH 120 using control information obtained through the demodulation result of HS-SCCH 110. However, if the demodulation result of HS-SCCH 110 is determined to be unreliable, the UE stops the demodulation of HS-PDSCH 120.

In the HSDPA system, the UE may generate an error with respect to HS-SCCH 110 in the following two cases.

Case 1) Even though a base station has transmitted a packet to a specific UE, the specific UE does not receive a packet contained in HS-PDSCH 120, determining that the demodulation result of HS-SCCH 110 is unreliable.

Case 2) Even though a base station has not transmitted a packet to a specific UE, a UE other than the specific UE receives a packet contained in HS-PDSCH 120, determining that the demodulation result of HS-SCCH 110 is reliable.

In Case 1), as the UE cannot normally receive the corresponding packet, packet retransmission occurs, causing a decrease in the entire throughput of the UE. In Case 2), the UE receives the packet, which is not transmitted to the UE itself, thereby unnecessarily consuming the power for demodulation of HS-PDSCH 120.

In order to reduce the reliability decision error for demodulation of HS-SCCH 110, the base station allows part #1 200a and part #2 200b of HS-SCCH 110 to distinguish a specific UE using different methods. That is, the part #1 200a of HS-SCCH 110 distinguishes a specific UE by masking UE specific ID. The part #2 200b includes UE specific CRC in addition to the H-ARQ related information described above.

### SUMMARY OF THE INVENTION

The present invention substantially addresses at least the above-described problems and/or disadvantages and provides at least the advantages described below. Accordingly, an aspect of the present invention is to provide an apparatus and method for transmitting and receiving a control channel for packet data transmission in a mobile communication system supporting high-speed packet data transmission.

Another aspect of the present invention is to provide an apparatus and method for encoding and decoding a control channel for packet data transmission in a mobile communication system supporting high-speed packet data transmission.

Still another aspect of the present invention is to provide a control information transmission/reception apparatus and method for packet data transmission in a mobile communication system supporting high-speed packet data transmission.

Yet another aspect of the present invention is to provide an apparatus and method in which a UE increases decoder reliability to determine reliability of received control information in a mobile communication system supporting high-speed packet data transmission.

According to an aspect of the present invention, there is provided a method for encoding a control channel to transmit high-speed packet data in a base station of a high-speed packet data communication system. The method includes encoding a User Equipment Identifier (UE ID) of a UE that will receive the high-speed packet data, and rate-matching the encoded UE ID to generate a first stream; generating an offset value for cyclic-shifting the first stream, using the UE ID; encoding control information that the UE needs to receive the high-speed packet data, and rate-matching the encoded control information to generate a second stream; cyclic-shifting each of the first stream and the second stream by the offset value; and masking the cyclic-shifted second stream with the cyclic-shifted first stream before transmission.

According to another aspect of the present invention, there is provided a method for decoding a control channel to receive high-speed packet data in a UE of a high-speed packet data communication system. The method includes receiving a stream including control information necessary for receiving the high-speed packet data from a base station; generating a first stream using a UE ID of the UE to unmask the received stream; generating an offset value for cyclic-shifting the first stream, using the UE ID; cyclic-shifting the first stream by the offset value; unmasking the received stream with the cyclic-shifted first stream to generate a second stream; cyclic-shifting the second stream by the offset value to generate a third stream; and decoding the third stream to acquire control information.

According to still another aspect of the present invention, there is provided an apparatus for encoding a control channel to transmit high-speed packet data in a base station of a high-speed packet data communication system. The apparatus includes a masking stream generator for encoding a UE ID of a UE that will receive the high-speed packet data, rate-matching the encoded UE ID to generate a first stream, and generating an offset value for cyclic-shifting the first stream; and a transmission stage for multiplexing and coding control information that the UE needs to receive the high-speed packet data, rate-matching the coded control information to generate a second stream, cyclic-shifting each of the first stream and the second stream by the offset value, and masking the cyclic-shifted second stream with the cyclic-shifted first stream before transmission.

According to yet another aspect of the present invention, there is provided an apparatus for decoding a control channel to receive high-speed packet data in a UE of a high-speed packet data communication system. The apparatus includes a masking stream generator for encoding and rate matching a UE ID of the UE to generate a first stream, and generating an offset value for cyclic-shifting the first stream; and a reception stage for receiving a stream including control information necessary for receiving the high-speed packet data from a base station, cyclic-shifting the first stream generated by the masking stream generator by the offset value, unmasking the received stream with the cyclic-shifted first stream to generate a second stream, cyclic-shifting the second stream by the offset value to generate a third stream, and decoding the third stream to acquire control information.

### BRIEF DESCRIPTION OF THE DRAWINGS

The above and other aspects, features and advantages of the present invention will become more apparent from the following detailed description when taken in conjunction with the accompanying drawings in which:

FIG. 1 is a diagram illustrating a conventional timing relationship between HS-SCCH and HS-PDSCH in an HSDPA system;

FIG. 2 is a diagram illustrating a conventional subframe structure of HS-SCCH in an HSDPA system;

FIG. 3 illustrates a block structure for encoding control information to be carried on a part #1 and masking the encoded control information in a base station of an HSDPA system according to a first embodiment of the present invention;

FIG. 4 illustrates a block structure for demodulating HS-SCCH in a UE of an HSDPA system according to the first embodiment of the present invention;

FIG. 5 is a block diagram of a base station for encoding HS-SCCH according to a second embodiment of the present invention;

FIG. 6 is a block diagram of a UE for decoding HS-SCCH according to the second embodiment of the present invention;

FIG. 7 is a block diagram of a UE specific masking unit for performing a masking operation in a base station according to the second embodiment of the present invention;

FIG. 8 is a block diagram of a UE specific unmasking unit in a UE1 under the condition of FIG. 10 according to the second embodiment of the present invention;

FIG. 9 is a block diagram of a UE specific unmasking unit in a UE2 under the condition of FIG. 10 according to the second embodiment of the present invention;

FIG. 10 is a diagram illustrating the situation in which a base station transmits an HS-SCCH channel to a UE2 in a forward direction;

FIG. 11 is a diagram illustrating operations of a UE1 and a UE2 in an HSDPA system according to the first embodiment of the present invention in the same environment as that of FIG. 10;

FIG. 12 is a diagram illustrating a relationship between a threshold and FQM for a description of a process in which a UE determines reliability of its received control information by comparing an FQM value with a threshold according to an embodiment of the present invention;

FIG. 13 is a flowchart illustrating a method in which a base station encodes a control channel to transmit packet data according to the second embodiment of the present invention;

FIG. 14 is a flowchart illustrating a method in which a UE decodes a control channel to receive packet data according to the second embodiment of the present invention; and

FIG. 15 is a diagram illustrating an effect of the UE in an operation performed according to the second embodiment of the present invention.

### DETAILED DESCRIPTION OF THE PREFERRED EMBODIMENTS

Preferred embodiments of the present invention will now be described in detail with reference to the drawings. In the following description, a detailed description of known functions and configurations incorporated herein has been omitted for clarity and conciseness.

Although a description of the present invention will be given herein with reference to a High Speed Downlink Packet Access (HSDPA) system proposed by 3^{rd} Generation Partnership Project (3GPP), as an example of the mobile communication system for high-speed packet data transmission, the present invention can be applied to other systems including, for example Code Division Multiple Access (CDMA) 2000 1× Evolution Data Only (EV-DO), Long Term Evolution (LTE), etc., which are systems for encoding and decoding control information for packet data transmission in a high-speed packet data communication system.

Before a description of the present invention is given, a description will be made of Masking and Unmasking on a User Equipment (UE) specific identifier (ID) in a 40-bit part #1 200a of High Speed Shared Control Channel (HS-SCCH) 110.

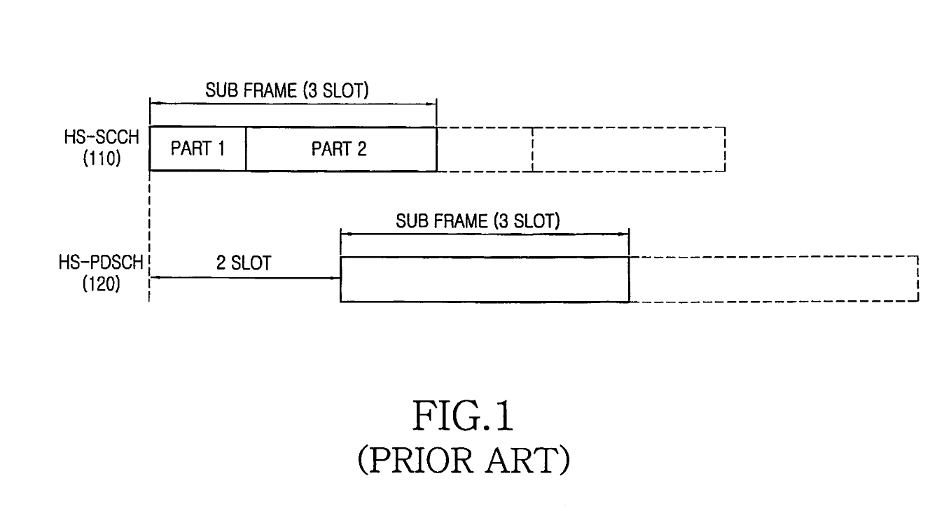

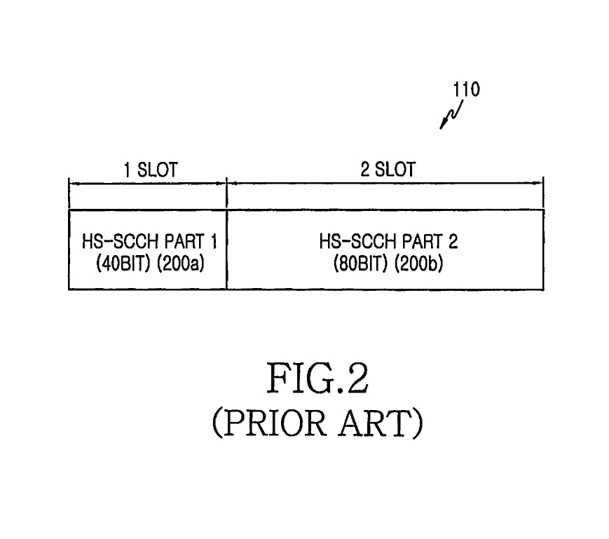

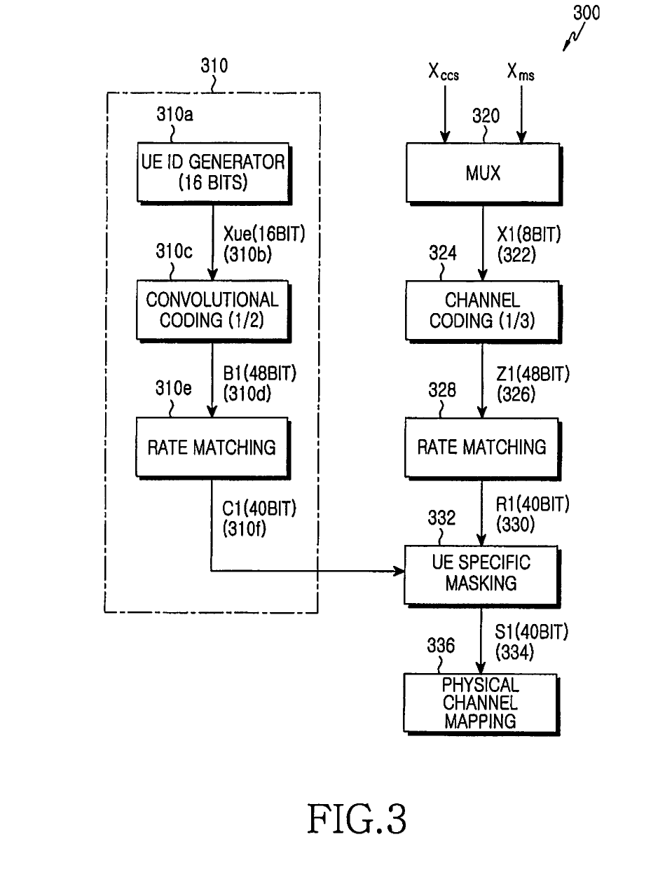

FIG. 3 illustrates a block structure for encoding control information to be carried on a part #1 200a, as shown in FIG. 2, and masking the encoded control information in a base station 300 of an HSDPA system according to a first embodiment of the present invention. Through the blocks shown in FIG. 3, the base station 300 delivers control information to a specific UE over HS-SCCH 110, as shown in FIG. 1.

A multiplexer (MUX) 320 multiplexes control information Modulation Scheme (MS) and Channelization Code Set (CCS) for a specific UE to generate an 8-bit bit stream X1 322. A channel coding unit 324 performs Viterbi coding on the input bit stream X1 322 to generate a 48-bit Z1 stream 326, and a rate matching unit 328 rate-matches the input Z1 stream 326 to generate a 40-bit R1 stream 330.

A UE specific masking unit 332 generates a 40-bit S1 stream 334 to be included in HS-SCCH 110 by eXclusive ORing (XORing) the 40-bit R1 stream 330 generated by the rate matching unit 328 and a 40-bit C1 stream 310f generated by a masking stream generator 310, and a physical channel mapping unit 336 maps the generated S1 stream 334 to one slot allocated to a part #1 in the subframe of HS-SCCH 110 before transmission.

In the masking stream generator 310, a UE ID generator 310a generates a 16-bit UE ID stream Xue 310b, and a convolution coding unit 310c Viterbi-codes the generated UE ID stream Xue 310b to generate a 48-bit B1 stream 310d. A rate matching unit 310e rate-matches the B1 stream 310d to generate a 40-bit C1 stream 310f, and outputs the C1 stream 310f to the UE specific masking unit 332. The channel coding unit 324 of FIG. 3 can be a Viterbi encoder.

The reason why the rate matching units 328 and 310e output 40-bit streams for their input streams is to map them to the part #1 200a in the same bit size because the part #1 200a has a 40-bit size.

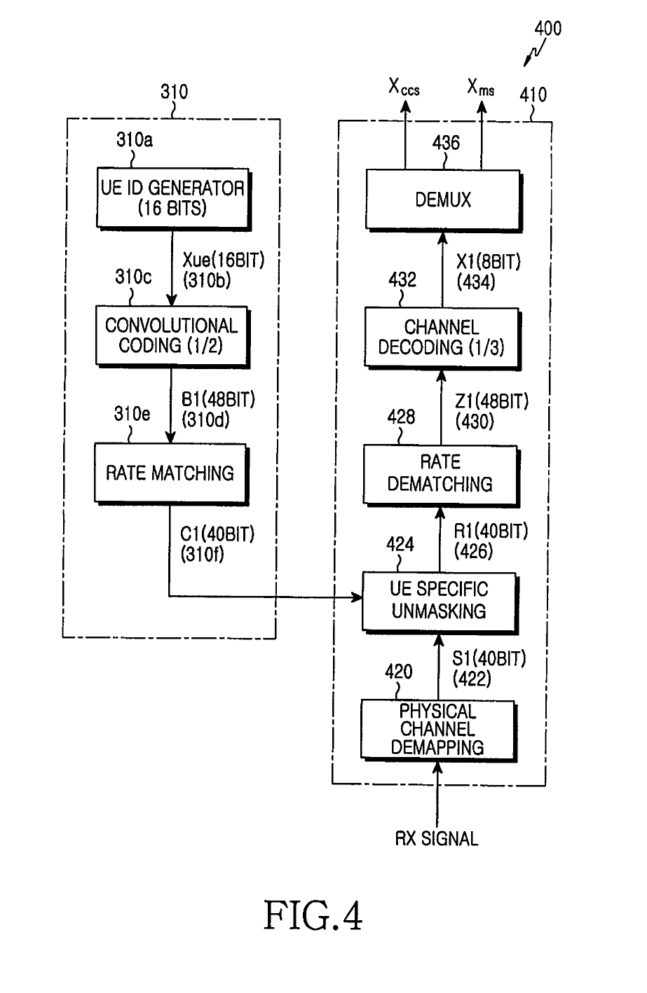

FIG. 4 illustrates a block structure for demodulating HS-SCCH in a UE 400 of an HSDPA system according to the first embodiment of the present invention. Through the blocks shown in FIG. 4, the UE 400 attempts demodulation on a part #1 of received HS-SCCH 110, as shown in FIG. 1. Since a masking stream generator 310 is equal to that of FIG. 3 in structure and operation, a description thereof will be omitted herein.

Referring to FIG. 4, a physical channel demapping unit 420 acquires a 40-bit S1 stream 422 from a part #1 200a in a subframe of HS-SCCH of a received signal. A UE specific unmasking unit 424 generates a 40-bit R1 stream 426 by XORing the S1 stream 422 and a 40-bit C1 masking stream 310f generated by the masking stream generator 310.

A rate dematching unit 428 rate-dematches the R1 stream 426 to generate a 48-bit Z1 stream 430, and a channel decoding unit 432 Viterbi-decodes the Z1 stream 430 to generate an 8-bit X1 stream 434.

After performing Viterbi decoding in the channel decoding unit 432, the UE 400 determines reliability of Viterbi decoding using a path metric obtained by performing Viterbi decoding. Although there are several methods for determining reliability, these are not related to the present invention, so a description thereof will be omitted herein for simplicity.

If Viterbi decoding is determined to be reliable, the UE 400 allows a demultiplexer (DEMUX) 436 to demultiplex the X1 stream 434, and controls a reception stage 410 to continue the demodulation of a part #2 200b of HS-SCCH 110 and the demodulation of the High Speed Physical Downlink Shared Channel (HS-PDSCH) 120 shown in FIG. 1. However, if Viterbi decoding by the channel decoding unit 432 is determined to be unreliable, the UE 400 does not attempt demodulation on the part #2 and HS-PDSCH 120.

The HSDPA system according to the first embodiment of the present invention uses decoding reliability of a Viterbi decoder in order for the UE 400 to demodulate HS-SCCH 110 and determine that HS-SCCH 110 has information transmitted to the UE 400 itself. For decision on the decoding reliability, a path metric value of a Viterbi decoder is generally used. That is, in a path selection process occurring in the decoding process, the UE 400 uses a value of a path metric stored in a Viterbi decoder. In other words, the UE 400 determines whether the currently received data is reliable, by making a comparison between a certain value calculated using a path metric obtained in the Viterbi decoding process and a particular threshold. For this purpose, the HSDPA system, to which the present invention can be applied, uses a method for unmasking a value of a bit stream being input to the Viterbi decoder using a unique masking sequence generated for UE ID, thereby increasing decoding reliability.

Therefore, reducing a decision error in the part where a comparison with a threshold is made in the decision process performed using the path metric obtained after Viterbi decoding can be considered as a purpose for generating the masking sequence.

In an HSDPA system according to the first embodiment of the present invention, when a part #1 of HS-SCCH is demodulated as described in FIG. 4, UE identification is achieved using only the masking sequence. That is, for a reliability decision on Viterbi decoding through a process of unmasking bit streams being input to the Viterbi decoder using a UE specific masking sequence generated by UE ID, the HSDPA system uses a method for determining reliability of decoding by comparing a value calculated using a path metric with a threshold during reliability decision based on the path metric. Therefore, for accurate detection of HS-SCCH, detection performance of a UE is improved when a value (for example, Frame Quality Metric (FQM)) calculated using the path metric is less than the threshold set in the UE.

However, a method according to the first embodiment of the present invention, because it performs convolution encoding using UE ID and uses the rate-matched sequence, may have difficulty in determining decoding reliability using the path metric, and may suffer performance degradation of UE especially in the poor wireless environment. That is, in the method according to the first embodiment of the present invention, for the UE that should not receive data due to the poor wireless environment, since FQM acquired as a result of decoding of a part #1 is less than the threshold, there is a high probability that the UE will attempt demodulation on a part #2 and data. Therefore, a second embodiment of the present invention, described below, will provide a scheme capable of reducing an error of decoding reliability decision compared to the first embodiment associated with FIGS. 3 and 4.

Because no Cyclic Redundancy Check (CRC) is attached to information of a part #1 200a of HS-SCCH 110 in the HSDPA system as described above, a UE determines whether control information transmitted using reliability of Viterbi decoding is its own information, and determines whether a packet contained in HS-PDSCH 120 transmitted 2 slots later is its own packet.

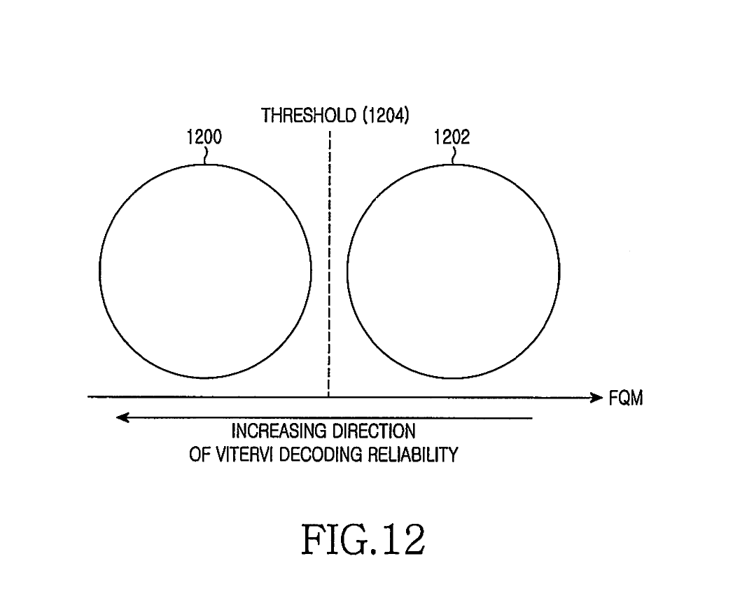

Reliability decision on Viterbi decoding is achieved through a comparison between a value obtained using a path metric of Viterbi decoding and a specific threshold. Therefore, in order to reduce an error occurring in a process of determining whether information of a part #1 200a of HS-SCCH 110 is its own information, the UE should be able to definitely determine whether an FQM value acquired using a path metric of Viterbi decoding is greater than or less than the threshold. That is, the second embodiment of the present invention is characterized in that a transmission side and a reception side use an offset value obtained by performing modulo operation on UE ID in a size of a part #1 so that an FQM acquired as a result of decoding by a UE that has received control information which is not its own information should be greater than or equal to a preset threshold. Therefore, in the second embodiment of the present invention, because there is an increasing difference between an FQM value for the case where the control information that the UE has received is its own information and an FQM value for the case where the control information that the UE has received is not its own information, the UE can simply make a decoding reliability decision. A description thereof will be given with reference to FIG. 12.

Therefore, the second embodiment of the present invention, described below, provides an apparatus and method in which a base station shifts a UE specific masking sequence and a rate-matched bit stream using UE ID before transmission, and a UE shifts the UE specific masking sequence and the received bit stream using UE ID in the opposite direction of the shift direction used in the base station to clarify whether a value obtained using a path metric of Viterbi decoding is greater than or less than a specific threshold, thereby reducing a reception error. The second embodiment of the present invention is not limited to the HSDPA system, and can be applied to all systems where a UE can identify control information, because it masks UE ID to control information before transmission.

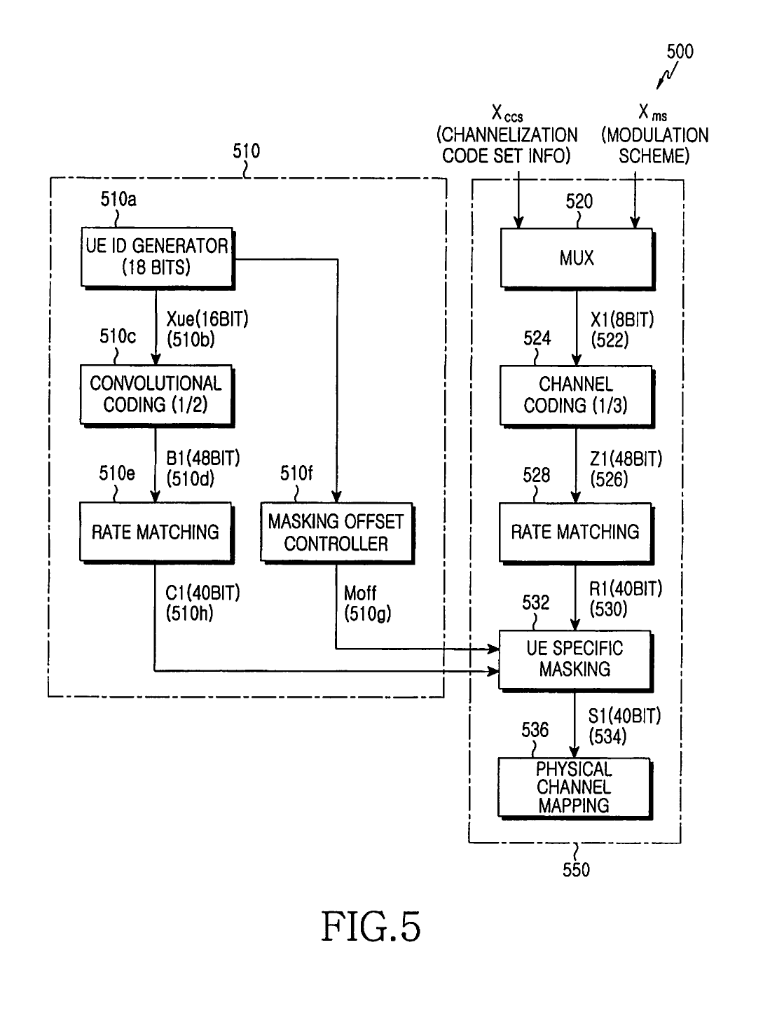

FIG. 5 shows a base station 500 for encoding HS-SCCH according to the second embodiment of the present invention. Specifically, FIG. 5 shows a technique for encoding a part #1 of HS-SCCH according to the present invention.

The base station 500 shown in FIG. 5 includes a masking stream generator 510 for generating a masking stream generated with UE ID and a masking offset value Moff used for shifting the stream generated using UE ID, and a transmission stage 550 for multiplexing and coding control information MS and CCS included in a part #1, rate-matching the control information, and shifting the masking stream generated by the masking stream generator 510 and a stream of the control information by the masking offset value Moff before transmission. Masking performed using UE ID can be equivalent to performing, for example, XOR operation using UE ID.

A UE ID generator 510a generates a 16-bit UE ID stream Xue 510b, and a convolution coding unit 510c convolution-codes the UE ID stream Xue 510b to generate a 48-bit B1 stream 510d. A rate matching unit 510e rate-matches the 48-bit B1 stream 510d to generate a 40-bit C1 stream 510h. At this time, a masking offset controller 510f outputs a masking offset value Moff, with which a UE specific masking unit 532 in the transmission stage 550 will perform shifting, using the 16-bit UE ID generated by the UE ID generator 510a. The UE ID refers to an ID of a specific UE that will receive the control information Xms and Xccs transmitted by the base station 500, and a method, in which the masking offset controller 510f generates Moff using UE ID, can generate the Moff by performing modulo operation on UE ID in a size (40 bits) of a part #1 200a. Because a size of a C1 stream and a size of an R1 stream each are also 40 bits, Moff can be acquired by performing modulo operation on UE ID in a size of the C1 stream or a size of the R1 stream.

That is, the masking offset controller 510f determines an offset used for shifting a masking sequence (C1 stream) 510h generated with UE ID of a UE to which it desires to deliver HS-SCCH, and an R1 stream 530 that has undergone Viterbi encoding and rate matching.

In the transmission stage 550, a multiplexer (MUX) 520 generates an 8-bit X1 stream 522 by multiplexing sequences Xms and Xccs needed by a receiving UE to demodulate received data, and a channel coding unit 524 encodes the 8-bit X1 stream 522 into a 48-bit Z1 stream 526. A rate matching unit 528 rate-matches the 48-bit Z1 stream 526 back to the 40-bit R1 stream 530.

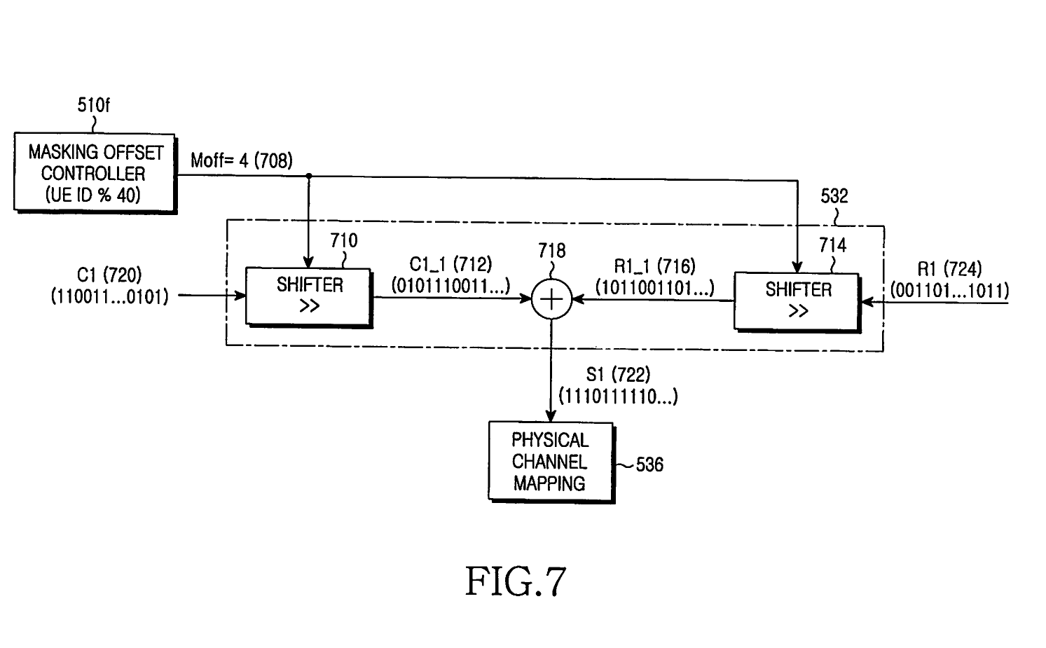

The UE specific masking unit 532 receives the R1 stream 530 rate-matched by the rate matching unit 528 and the C1 stream 510h rate-matched by the rate matching unit 510e in the masking stream generator 510, and generates an S1 stream 534 by shifting them by the Moff value generated by the masking offset controller 510f. The S1 stream 534 shifted by the Moff value is transmitted to the UE by means of a physical channel mapping unit 536. The UE specific masking unit 532 will include two right shifters for performing shifting according to a value of the masking offset Moff determined by the masking offset controller 510f, and an XOR unit, and a method and structure in which the UE specific masking unit 532 shifts the C1 stream 510h and the R1 stream 530 according to the Moff 510g will be described in detail with reference to FIG. 7.

The second embodiment of the present invention can also generate the masking offset value by further puncturing n bits when performing the rate matching from a 48-bit stream to a 40-bit stream.

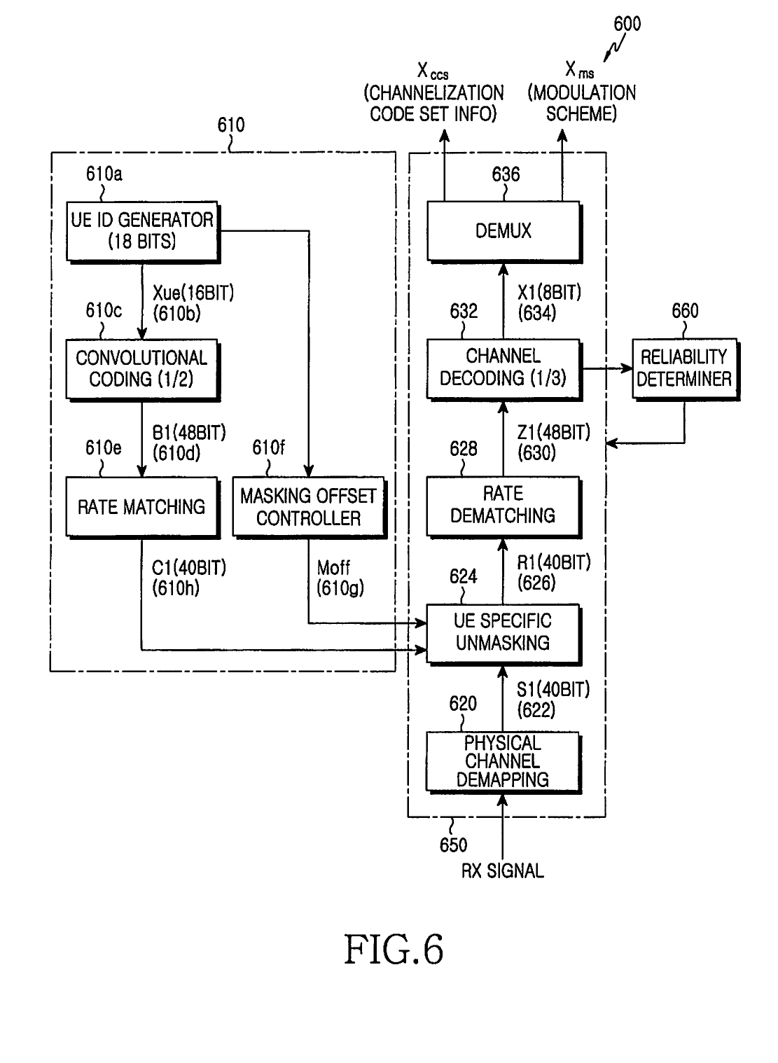

FIG. 6 shows a UE 600 for decoding HS-SCCH 110 according to the second embodiment of the present invention. Specifically, FIG. 6 shows a technique for decoding a part #1 of HS-SCCH 110 according to the present invention.

A UE 600 according to the second embodiment of the present invention includes a masking stream generator 610 which is equal in operation to the masking stream generator 510 of the base station 500.

The UE 600 shown in FIG. 6 includes the masking stream generator 610 for generating a masking stream generated with UE ID and a masking offset value Moff used for shifting the masking stream generated using UE ID, a reception stage 650 for acquiring MS and CCS by decoding control information after shifting again the received signal by the masking offset value and unmasking the shifted signal, and a reliability determiner 660 for determining decoder reliability of the reception stage 650, and determining based on the determination result whether it will allow the reception stage 650 to continuously receive the received signal and continuously decode the control information included in a part #2 and the data transmitted over HS-PDSCH. A UE ID generator 610a generates a 16-bit UE ID stream Xue 610b, and a convolution coding unit 610c encodes the UE ID stream Xue 610b to generate a 48-bit B1 stream 610d. A rate matching unit 610e rate-matches the 48-bit B1 stream 610d to generate a 40-bit C1 stream 610h. At this time, a masking offset controller 610f outputs a masking offset value Moff, with which a UE specific unmasking unit 624 in the reception stage 650 will perform shifting, using the 16-bit UE ID generated by the UE ID generator 610a. Herein, the UE ID means an ID of the UE 600, and a method, in which the masking offset controller 610f generates Moff using UE ID, can generate the Moff by performing modulo operation on UE ID in a size (40 bits) of a part #1 200a. Similarly, the UE 600 can also acquire the Moff by performing modulo operation on UE ID in a size of the 40-bit C1 stream 610h.

A description will now be made of the reception stage 650 according to the second embodiment of the present invention.

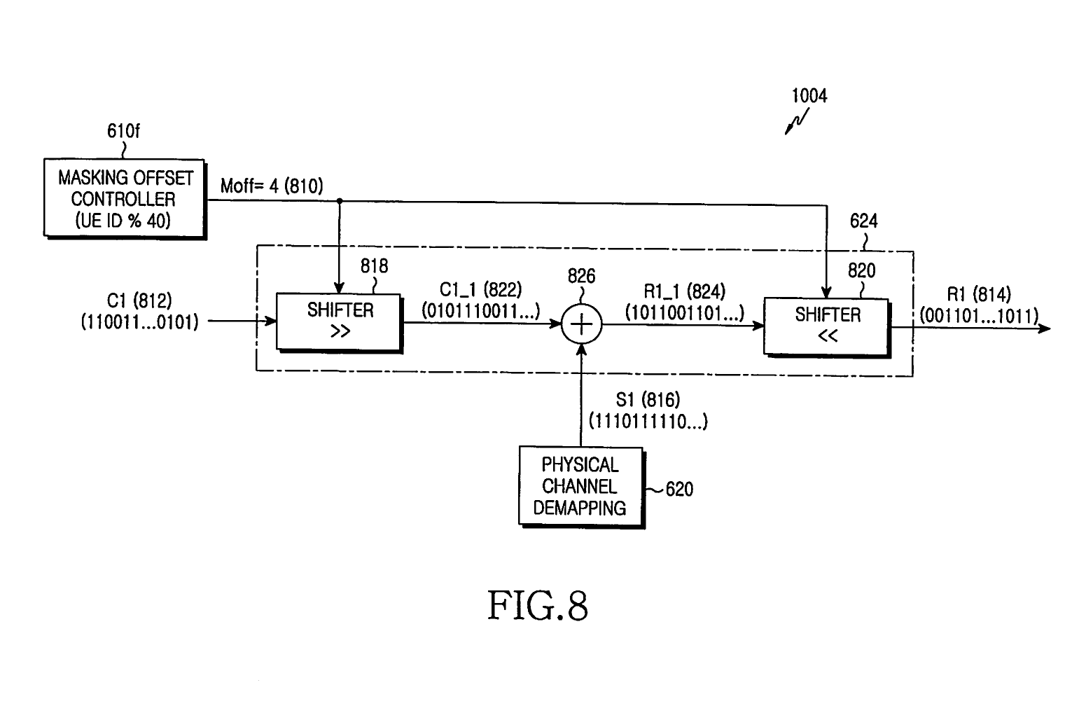

A received signal is output as a 40-bit S1 stream 622 by means of a physical channel demapping unit 620, and the UE specific unmasking unit 624 generates a 40-bit R1 stream 626 by shifting the S1 stream 622 and the C1 stream 610h output from the rate matching unit 610e by the Moff value 610g and then XORing them. The unmasking operation performed by the UE specific unmasking unit 624 will be described below with reference to FIG. 8.

The 40-bit R1 stream 626 that underwent unmasking in the UE specific unmasking unit 624 is converted into a 48-bit Z1 stream 630 by a rate dematching unit 628, and then output as an 8-bit X1 stream 634 by a channel decoding unit 632. A demultiplexer (DEMUX) 636 acquires control information Xccs and Xms by demultiplexing the 8-bit X1 stream 634. At this point, the reliability determiner 660 determines reliability of the decoding performed in the channel decoding unit 632, and if it is determined that the decoding is reliable, the reliability determiner 660 instructs the reception stage 650 to continuously decode the received signal, because the received signal is its own received information. However, if the decoding is unreliable, the reliability determiner 660 instructs the reception stage 650 to stop the demodulation on the received signal.

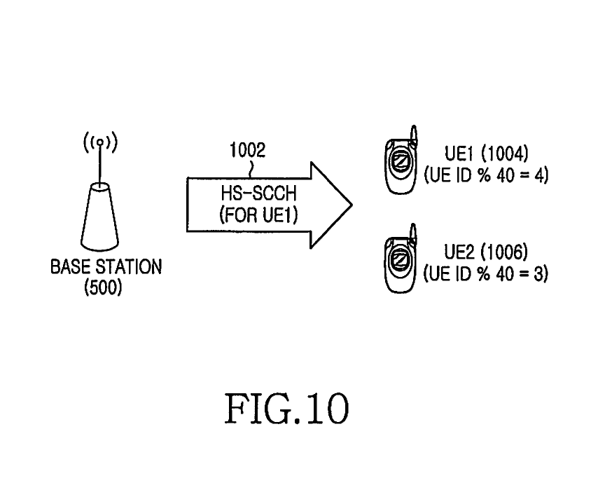

FIGS. 7 to 9 show techniques for performing encoding and decoding on control information of the base station 500 and the UE 600 according to the second embodiment of the present invention, and a description thereof will be made in a situation considered in FIG. 10.

FIG. 10 illustrates a situation considered for a better understanding of the present invention, and in this situation, a base station 500 transmits an HS-SCCH channel to a UE1 1004 in a forward direction to transmit data to the UE1 1004. In FIG. 10, reference numeral 1002 shows that the base station 500 transmits an HS-SCCH channel to the UE1 1004 in the forward direction. In the situation of FIG. 10, the UE1 1004 and a UE2 1006 are located in coverage of the base station 500. Shown in FIG. 10 is the case where the UE1 1004 satisfies a condition of UE ID % 40=4, and the UE2 1006 satisfies a condition of UE ID % 40=3. The base station 500 intends to transmit control information to the UE1 1004 over a shared channel HS-SCCH as shown by reference numeral 1002. That is, because the UE2 1006 has no need to demodulate the data transmitted by the base station 500, it should not attempt demodulation on a part #2 of the HS-SCCH 1002 and HS-PDSCH transmitted by the base station 500. A detailed description of the embodiment of the present invention will now be given in the situation considered in FIG. 10.

FIG. 7 shows a UE specific masking unit 532 for performing a masking operation in a base station 500 according to the second embodiment of the present invention. The UE specific masking unit 532 according to the second embodiment of the present invention includes two right shifters 710 and 714 where shifting is performed according to a masking offset value Moff determined by a masking offset controller 510f, and an XOR unit 718. In FIG. 7, the masking offset controller 510f determines a desired shift offset value in accordance with Equation (1) using UE ID of the UE1 1004 in FIG. 10, to which the base station 500 intends to transmit control information over HS-SCCH.

Moff(Masking offset)=UEID%40 (1)

UE ID of the UE1 1004 is herein assumed to be 4. In this case, Moff is 4. In Equation (1), ‘40’ used for performing modulo operation means a size of a part #1 described above. A size of an R1 stream or a size of a C1 stream, which is equal to the size of the part #1 used for performing modulo operation on UE ID, can also be used in place of the size of the part #1.

In FIG. 7, C1 720 is a UE specific masking sequence that the masking stream generator 510 obtained using UE ID of a specific UE to which it desires to transmit control information over HS-SCCH. The C1 720 is assumed to be as follows.

C1=110011 . . . 0101

R1 724 is a bit stream that the transmission stage 550 obtained after performing Viterbi encoding and rate matching processes on the control information. R1 724 is assumed to be as follows.

R1=001101 . . . 1011

The base station 500 inputs the Moff value calculated by the masking offset controller 510f to a first shifter 710. The first shifter 710 cyclic-shifts the C1 stream rightward by the Moff value 708 to obtain a C1_1 stream 712. The C1_1 stream 712 is defined as Equation (2), where a value of Moff is 4.

C1_{—}1=C1>>Moff=0101110011 (2)

In the base station 500, the UE specific masking unit 532 inputs the Moff value 708 calculated by the masking offset controller 510f to a second shifter 714. The second shifter 714 cyclic-shifts the R1 stream 724 rightward by the Moff value 708 to obtain an R1_1 stream 716. The R1_1 stream 716 is defined as Equation (3), where a value of Moff is 4.

R1_{—}1=R1>>Moff=1011001101 (3)

The XOR unit 718 in the UE specific masking unit 532 calculates an S1 stream 722 by XORing the C1_1 stream 712 and the R1_1 stream 716. The calculated S1 stream 722 is defined as Equation (4).

S1=C1_{—}1XORR1_{—}1=1110111110 (4)

The physical channel mapping unit 536 of the base station 500 maps the S1 stream 722 to a part #1 200a of HS-SCCH.

FIG. 8 shows a UE specific unmasking unit 624 in a UE1 1004 under the condition of FIG. 10 according to the second embodiment of the present invention. Shown in FIG. 8 is a process in which the UE1 1004 generates an R1 stream 814 from an S1 stream 816 according to the second embodiment of the present invention.

The masking offset controller 610f and the UE specific unmasking unit 624 of FIG. 6 are units associated with an unmasking operation of the UE 11004.

The masking offset controller 610f determines an offset value Moff used for cyclic-shifting a masking sequence (C1 stream) 812 generated with its own UE ID, and an offset value Moff used for cyclic-shifting an R1_1 stream 824 obtained by XORing the S1 stream 816 of HS-SCCH received from the base station 500 and a C1_1 stream 822 obtained by cyclic-shifting the C1 stream 812.

The UE specific unmasking unit 624 includes one left shifter 820 and one right shifter 818, for performing cyclic shifting according to the masking offset values Moff determined by the masking offset controller 610f, and an XOR unit 826. Although the masking offset controller 610f and the UE specific unmasking unit 624 are included even in the UE2 1006 in the same way, different reference numerals will be used for convenience of description.

UE ID of the UE1 1004 is assumed to be 4. The masking offset controller 610f calculates a Moff value using Equation (1). Therefore, the Moff value is 4.

The C1 stream 812 is a UE specific masking sequence calculated using UE ID of the UE1 1004. The C1 stream 812 has the same value as the C1 stream 720 calculated by the masking offset controller 510f of the base station 500 in FIG. 7. This is because the masking stream generator 510 and the masking stream generator 610 use the same UE ID for Viterbi encoding/decoding and rate matching/dematching processes. Therefore, the C1 stream 812 is defined as follows.

C1=110011 . . . 0101

In the UE1 1004, the first shifter 818 of the UE specific unmasking unit 624 cyclic-shifts the C1 stream 812 rightward by the Moff value 810 to calculate the C1_1 stream 822, as shown in Equation (5), where a value of Moff is 4.

C1_{—}1=C1>>Moff=0101110011 (5)

In the UE1 1004, the XOR unit 826 of the UE specific unmasking unit 624 calculates the R1_1 stream 824 by XORing the S1 stream 816 obtained by means of the physical channel demapping unit 620 and the C1_1 stream 822, and this process is defined as Equation (6).

R1_{—}1=S1XORC1_{—}1=1011001101 (6)

The second shifter 820 of the UE1 1004 obtains the R1 stream 814 by cyclic-shifting the R1_1 stream 824 leftward by the Moff value calculated by the masking offset controller 610f as shown in Equation (7), where a value of Moff is 4.

R1=R1_{—}1<<Moff=001101 . . . 1011 (7)

This shows that the R1 stream 814 received at the UE1 1004 is equal to the R1 stream 724 generated in FIG. 7 by the base station.

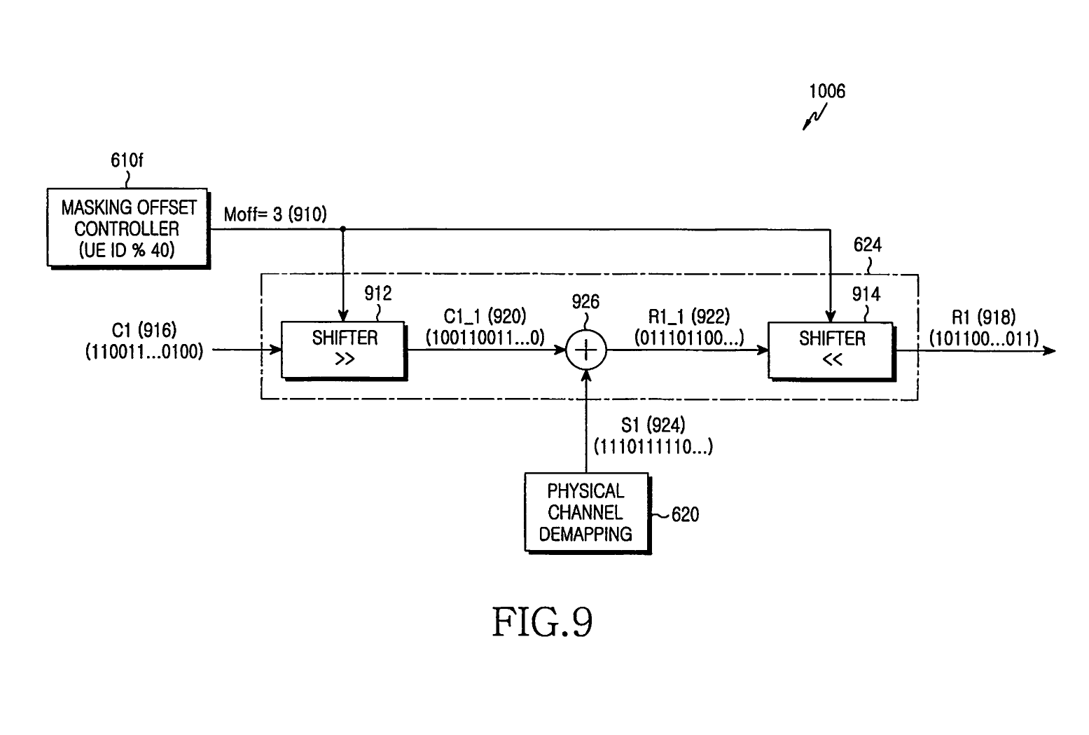

FIG. 9 shows a UE specific unmasking unit 624 in a UE2 1006 under the condition of FIG. 10 according to the second embodiment of the present invention.

UE ID of the UE2 1006 is assumed to satisfy a condition of UE ID % 40=3. Therefore, a Moff value calculated by the masking offset controller 610f of the UE2 1006 is 3.

For convenience, it is assumed in FIG. 9 that a UE specific sequence (C1 stream) 916 calculated using UE ID of the UE2 1006 is equal in many parts to the UE specific sequence of the UE1 1004. That is, it will be assumed that even though UE IDs are different, C1 streams of UE1 and UE2 can be very similar by simply performing Viterbi encoding and rate matching on the UE IDs. It will be assumed herein that there is only 1-bit difference between the C1 stream 812 of the UE1 1004 and the C1 stream 916 of the UE2 1006.

Therefore, in FIG. 9, the C1 stream 916 is assumed to be as follows.

C1=110011 . . . 0100

A first shifter 912 of the UE2 1006 obtains a C1_1 stream 920 by cyclic-shifting the C1 stream 916 rightward by a Moff value 910 as shown in Equation (8), where a value of Moff is 3.

C1_{—}1=C1>>Moff=10011001 . . . 0 (8)

In the UE2 1006, an XOR unit 926 calculates an R1_1 stream 922 by XORing an S1 stream 924 acquired by means of the physical channel demapping unit 620 and the C1_1 stream 920 cyclic-shifted by the first shifter 912 as shown in Equation (9).

R1_{—}1=S1XORC1_{—}=011101100 (9)

A second shifter 914 of the UE2 1006 obtains an R1_1 stream 918 by cyclic-shifting the R1_1 stream 922 leftward by the Moff value calculated by the masking offset controller 610f as shown in Equation (10), where a value of Moff is 3.

R1=R1_{—}1<<Moff=101100 . . . 011 (10)

According to the second embodiment of the present invention, since the stream R1 814 unmasked in FIG. 8 is different from the stream R1 918 unmasked in FIG. 9 as described above, if the control information on HS-SCCH transmitted by the base station 500 is information for the UE1 1004 as assumed above, an error occurs in the channel decoding unit 632 of the UE2 1006. Therefore, the UE2 1006 cannot demodulate the data for the UE1 1004. As a result, the channel decoding unit 632 of the UE2 1006 reduces reliability of its reliability decision. This causes an increase in FQM, and due to the increase in FQM, the UE2 1006 determines that a packet contained in HS-PDSCH transmitted 2 slots later is not its own packet. That is, the UE2 1006 stops the demodulation of a part #2 of HS-SCCH, and HS-PDSCH. In other words, the second embodiment of the present invention shifts the C1 stream using the UE specific ID, thereby increasing reliability of the decoding unit compared with the first embodiment.

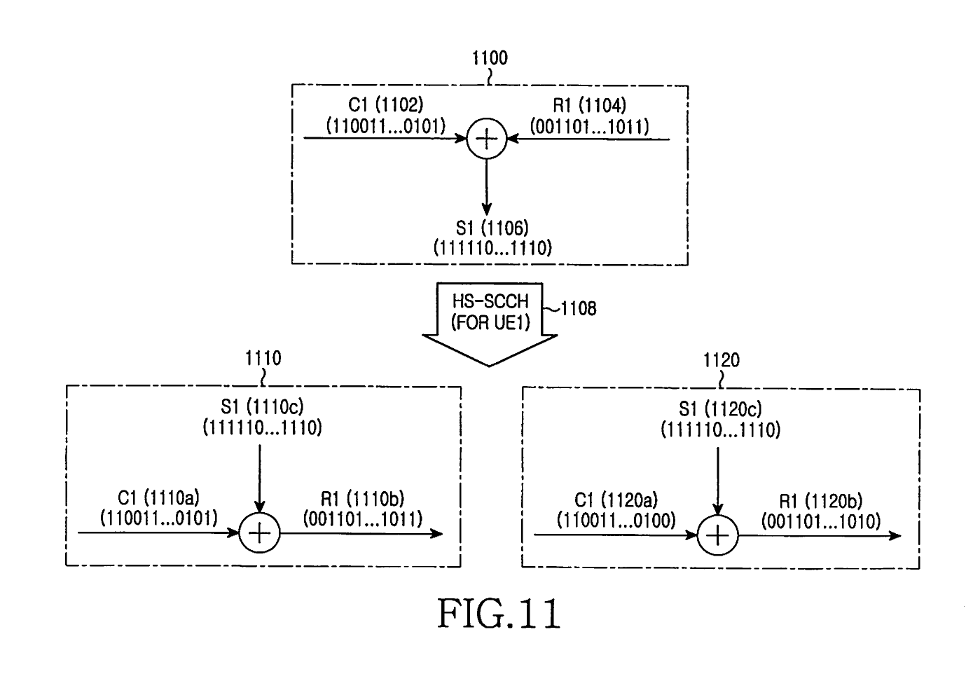

FIG. 11 is a diagram illustrating operations of a UE1 1004 and a UE2 1006 in an HSDPA system according to the first embodiment of the present invention in the same environment as that of FIG. 10 for a description of the effect of the present invention.

In FIG. 11, reference numeral 1110 shows a process in which the UE1 1004 generates an R1 stream 1110b by XORing an S1 stream received from a base station 1100 and its own UE specific masking sequence (C1 stream) 1110a, and reference numeral 1120 shows a process in which the UE2 1006 generates an R1 stream 1120b by XORing the S1 stream received from the base station 1100 and its own UE specific masking sequence (C1 stream) 1120a.

It is assumed in FIG. 11 that the C1 stream 1110a, or the UE specific masking sequence of the UE1 1110, is equal in many parts to the C1 stream 1120a, or the UE specific masking sequence of the UE2 1120, as assumed in FIG. 10. It is assumed herein that there is only 1-bit difference between the C1 stream 1110a of the UE1 and the C1 stream 1120a of the UE2, i.e., they are very similar to each other. Therefore, in the HSDPA system according to the first embodiment of the present invention, the R1 stream 1120b of the UE2 1006 is equal in many parts to an R1 stream 1104 of the base station 1100 as shown by reference numeral 1120. That is, the R1 stream 1120b of the UE2 1120 is defined as follows.

R1=001101 . . . 1010

FIG. 11 shows a problem that as the base station 1100, the UE1 1110 and the UE2 1120 perform an operation of masking and unmasking streams using UE ID according to the first embodiment of the present invention and the base station 1100 transmits streams without performing shifting using the UE ID-based masking offset values, not only the UE1 1110 but also the UE2 1120 may attempt demodulation on the part #2 and data, determining that they have high reliability for an S1 stream 1106 transmitted to the UE1 1110 by the base station 1100, for the following reason. That is, since there is no significant difference between the R1 stream of the UE1 1110 and the R1 stream of the UE2 1120, there is a high probability that the channel decoding unit 432 of the UE2 1120 in FIG. 11 will determine that reliability for the R1 stream is high. Therefore, to prevent such misoperation, the second embodiment of the present invention provides a scheme for cyclic-shifting the C1 stream using UE ID, thereby increasing reliability of the decoder.

In FIG. 11, the base station 1100 maps the S1 stream 1106 obtained by XORing the C1 stream 1102 and the R1 stream 1104 for the UE1 1110, to a part #1 of HS-SCCH before transmission. The UE1 1110 generates the same R1 stream 1110b as the R1 stream 1104 generated by the base station 1100, by XORing a received S1 stream 1110c and the C1 stream 1110a generated using its own UE ID. The UE2 1120 may determine that the reliability is high, when its C1 stream 1120a is similar in many parts to the C1 stream 1110a of the UE1 1110, so the UE2 1120 determines that the reliability is high for the R1 stream 1120b demodulated from an S1 stream 1120c received from the base station 1100. That is, when an R1 stream which is significantly different from the R1 stream generated by the base station 1100 is received at the Viterbi decoder, the reliability decreases.

Since the R1 stream 1110b is control information that should be transmitted to the UE1 1110, it is reasonable for the UE1 1110 to demodulate a part #2 following the R1 stream (part #1), and data. However, when the UE2 1120 attempts demodulation on the part #2 and the data, the UE2 1120 may attempt unnecessary demodulation on the control information, which is not its own information, and the data, thereby reducing the processing capability of the system and the UE2 1120, and increasing the power consumption.

The calculated R1 stream 1120b undergoes rate dematching and Viterbi decoding processes.

The UE2 1120, after performing Viterbi decoding, determines reliability of the Viterbi decoding. Although the reliability of Viterbi decoding can be determined in several methods, a difference (absolute value) in a path metric value between the final survivor path and the competitor path, both of which are input with 0-state, will be used herein as FQM of the Viterbi decoder.

FQM is one of the criteria indicating reliability of Viterbi-decoded data, and is a value corresponding to soft decision of Yamamoto bits proposed by Hirosuke Yamamoto. That is, when reliability of Viterbi decoding is high, FQM has a value less than a specific threshold, and when the reliability is low, FQM has a value higher than the specific threshold. Herein, the threshold, which is a value that can be obtained through experiments such as the field test, will be determined as an appropriate value based on which the UE can determine reliability for its received control information. That is, FIG. 12 is a diagram illustrating a relationship between a threshold and FQM for a description of a process in which a UE determines reliability of its received control information by comparing an FQM value with a threshold according to an embodiment of the present invention.

Therefore, it can be understood from FIG. 12 that the UE determines reliability of Viterbi decoding depending on a relationship between a threshold and FQM.

A threshold 1204 is a value predetermined to determine reliability of decoding, and FQM is a value generated as a result of decoding on the R1 stream. If FQM generated as a result of decoding on the R1 stream is lower than the threshold 1204 (see a region indicated by reference numeral 1200), the UE determines that reliability for the received R1 stream is high, so that it can determine that the received stream is its own information. However, if the FQM generated as a result of decoding on the R1 stream is greater than the threshold 1204 (see a region indicated by reference numeral 1202), the UE determines that reliability for the received R1 stream is low, so that it can determine that the received stream is not its own information.

That is, the UE, after completing Viterbi decoding with the threshold 1204 preset as shown in FIG. 12, determines whether part #1-control information of the currently received HS-SCCH is its own information, through a comparison between the FQM and the threshold 1204. That is, for the FQM which is less than the threshold 1204 as shown by reference numeral 1200, since reliability of Viterbi decoding is high, the UE continues the reception of both part #2-control information of HS-SCCH and HS-PDSCH, determining that the part #1-control information of the currently received HS-SCCH is its own information. It can be noted that the UE2 according to the first embodiment of the present invention, shown in FIGS. 10 and 11, erroneously attempts demodulation on part #2-control information of HS-SCCH and HS-PDSCH, determining that part #1-control information of the currently received HS-SCCH is its own information, since FQM obtained as a result of Viterbi decoding is less than the threshold 1204 due to the similarity between an R1 stream generated from an S1 stream received from the base station and the R1 stream generated by the UE1.

Such errors occur because the R1 stream of the base station and the R1 stream of the UE2 are equal in many parts as described in FIG. 11 when the first embodiment of the present invention is applied. That is, this is because the bit stream generated by the Viterbi encoder of the base station is equal in many parts to the bit stream being input Viterbi decoder of the UE2, and due to this, the FQM of the Viterbi decoder in the UE2 has a value less than the threshold 1204 of FIG. 12.

FIG. 11 considers the case where C1 streams of the UE1 and the UE2 are similar to each other in the operation according to the first embodiment of the present invention. That is, shown in FIG. 11 is a drawing for a description of the case where in the operation according to the first embodiment of the present invention, even though the base station intends to send control information to the UE1, the UE2 erroneously determines that the part #1-control information for the UE1, transmitted by the base station, is its own information because the C1 streams of the UE1 and the UE2 are similar to each other.

Since the R1 stream of the UE2 is similar to the R1 stream of the base station, when the UE2 performs Viterbi decoding and determines reliability, FQM generated as a result of the Viterbi decoding has a value less than the threshold. As a result, as the FQM is less than the threshold preset in FIG. 12, the UE2 receives control information, which is not its own information, and continues the demodulation of part #2 of HS-SCCH and the demodulation of HS-PDSCH.

In summary, in the first embodiment of the present invention, even though the base station intends to actually transmit control information to the UE1, the UE2 may erroneously receive information, which is not its own information, and a packet, since the C1 stream of the UE2 is similar to the C1 stream of the UE1.

However, in the operation according to the second embodiment of the present invention, shown in FIG. 9, the R1 stream 918 in the UE2 1006 is defined as Equation (11).

R1=R1_{—}1<<Moff=101100 . . . 011 (11)

The R1 stream 724 that the base station 500 has obtained by performing rate matching and Viterbi encoding on the control information that it desires to transmit to the UE1 1004 in FIG. 7, is defined as follows.

R1=001101 . . . 1011

It can be noted that the R1 stream 918 of the UE2 1006, obtained in FIG. 9 according to the second embodiment of the present invention, is different from the R1 stream 724 of the base station 500, obtained in FIG. 7 according to the second embodiment of the present invention, due to the effect of the Moff value 708 based on UE ID as described above.

Therefore, the UE2 1006, after performing rate dematching and Viterbi on the R1 stream 918 obtained in FIG. 9, determines reliability of the Viterbi Due to a difference between the R1 stream 724 generated by the base station and the R1 stream 918 of the UE2 1006, the bit stream being input to the Viterbi of the UE2 1006 has a difference with the output value of the Viterbi encoder of station 500. This difference contributes to an increase in the FQM when the UE2 1006 determines Viterbi decoding reliability.

Due to this, when the UE2 1006 makes a reliability decision on Viterbi decoding, the FQM generated as a result of the Viterbi decoding is placed in the region represented by reference numeral 1202, so that it is greater than the preset threshold 1204. As a result, the UE2 1006 stops the demodulation on part #2-control information of HS-SCCH and on HS-PDSCH, determining that the part #1-control information of the currently transmitted HS-SCCH is not its own information.

However, the R1 stream 918 of the UE2, acquired in FIG. 9 according to the second embodiment of the present invention, is defined as Equation (12).

R1=R1_{—}1<<Moff=101100 . . . 011 (12)

The R1 stream 724 that the base station 500 has obtained by performing rate matching and Viterbi encoding on the control information that it intends to transmit to the UE1 1004 in FIG. 7, is defined as follows.

R1=001101 . . . 1011

The R1 stream 918 of the UE2 1006, acquired in FIG. 9 according to the second embodiment of the present invention, is different from the R1 stream 724 of the base station 500, acquired in FIG. 7 according to the second embodiment of the present invention, due to the Moff value 708 based on UE ID as described above.

The UE2 1006, after performing rate dematching and Viterbi decoding on the R1 stream 918 acquired in FIG. 9, determines reliability of Viterbi decoding. However, due to the difference between the R1 stream 724 generated by the base station 500 in FIG. 7 and the R1 stream 918 of the UE2 1006, the stream being input to the Viterbi decoder (channel decoding unit) of the UE2 1006 has a difference with the output value of the Viterbi encoder of the base station. This difference contributes to an increase in the FQM when the UE2 1006 makes a reliability decision on the Viterbi decoding. Due to this, when the UE2 1006 makes a reliability decision on the Viterbi decoding, the acquired FQM is greater than the preset threshold. As a result, the UE2 1006 stops the demodulation on part #2-control information of HS-SCCH and on HS-PDSCH, determining that the part #1-control information of the currently transmitted HS-SCCH is not its own information.

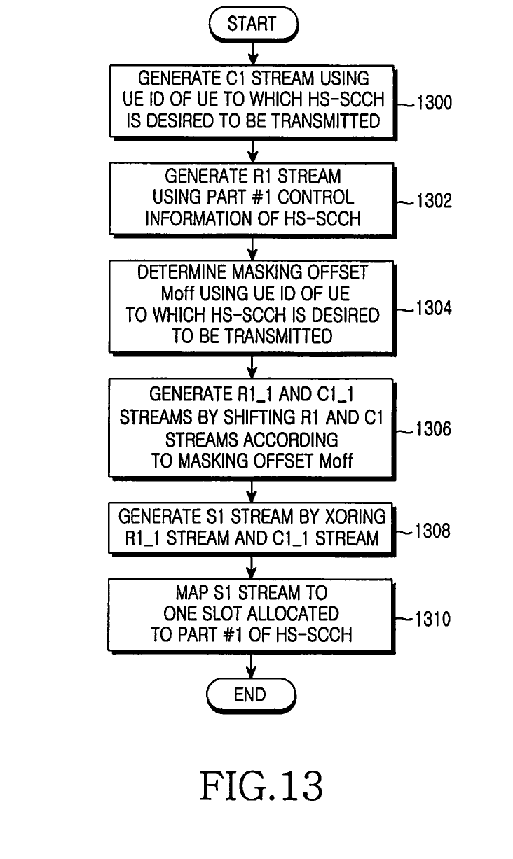

FIG. 13 shows a method in which a base station 500 encodes a control channel to transmit packet data according to the second embodiment of the present invention.

In step 1300, the base station 500 in FIG. 5 generates a C1 stream 720 using a UE ID of a UE to which it desires to transmit HS-SCCH. In step 1302, the base station 500 generates an R1 stream 724 using part #1-control information of HS-SCCH. In step 1304, the base station 500 determines a Moff value 708 using UE ID of a UE to which it desires to transmit HS-SCCH. In step 1306, the base station 500 generates an R1_1 stream 716 and a C1_1 stream 712 by cyclic-shifting the generated R1 and C1 streams by the Moff value 708 determined in step 1304, respectively. In step 1308, the base station 500 generates an S1 stream 722 to be transmitted to a UE, by XORing the R1_1 stream 716 and the C1_1 stream 712. In step 1310, the base station 500 maps the generated S1 stream 722 to one slot allocated to a part #1 of HS-SCCH, before transmission.

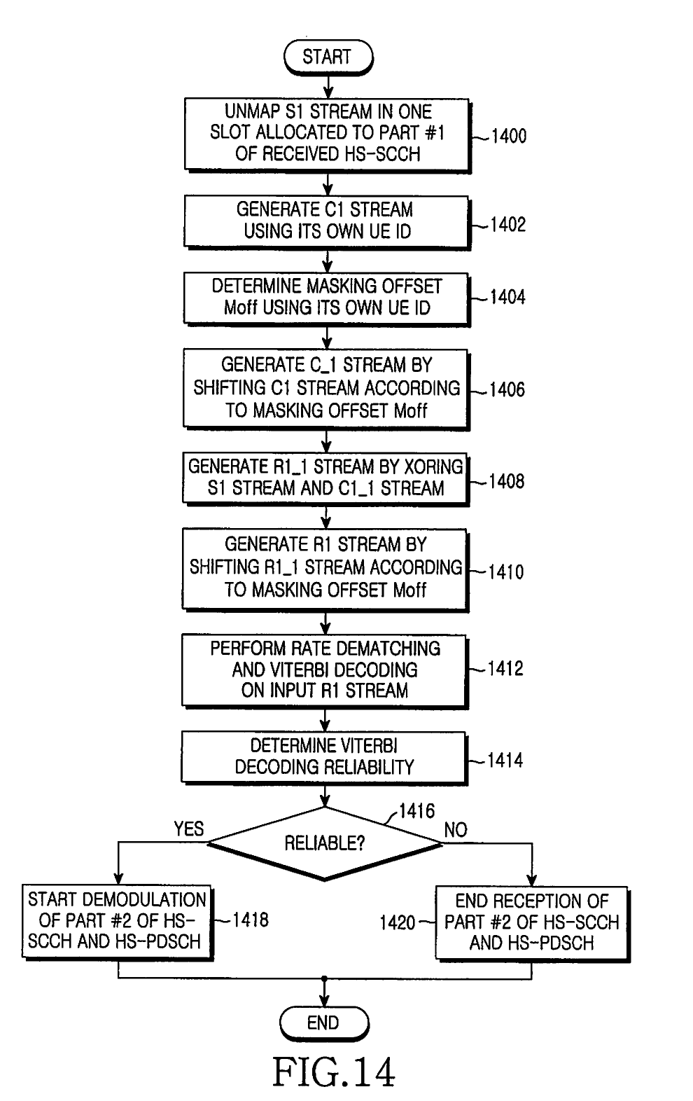

FIG. 14 shows a method in which a UE 1004 decodes a control channel to receive packet data according to the second embodiment of the present invention.

In step 1400, the UE 1004 in FIG. 10 demaps an S1 stream 816 in one slot allocated to a part #1 of HS-SCCH received from a base station 500. In step 1402, the UE 1004 generates a C1 stream 812 using its own UE ID. In step 1404, the UE 1004 determines a masking offset value Moff 810 using its own UE ID. In step 1406, the UE 1004 generates a C1_1 stream 822 by cyclic-shifting the C1 stream 812 by the Moff value determined in step 1404. In step 1408, the UE 1004 generates an R1_1 stream 824 by XORing the S1 stream 816 and the C1_1 stream 822.

In step 1410, the UE 1004 generates an R1 stream 814 by cyclic-shifting the R1_1 stream 824 by the Moff value 810. In step 1412, the UE 1004 performs rate dematching and Viterbi decoding on the R1 stream 814. After completing the Viterbi decoding in step 1412, the UE 1004 determines reliability of the Viterbi decoding in step 1414. If it is determined in step 1416 that the Viterbi decoding is reliable, the UE 1004 proceeds to step 1418 where it starts demodulation of a part #2 of HS-SCCH and HS-PDSCH, transmitted from the base station. However, if the Viterbi decoding is unreliable, the UE 1004 stops the reception of the part #2 of HS-SCCH and HS-PDSCH in step 1420. The Viterbi decoding reliability determined in step 1414 is achieved by comparing the FQM generated as a result of the Viterbi decoding with a preset threshold as described above.

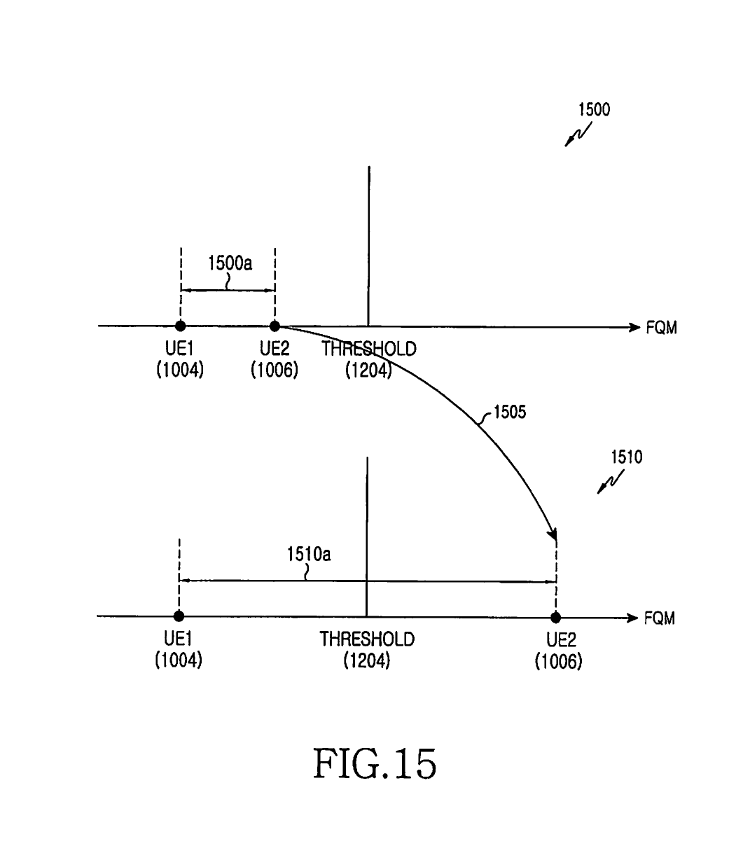

FIG. 15 illustrates an effect of a UE in an operation performed according to the second embodiment of the present invention. According to the second embodiment of the present invention, as the base station cyclic-shifts streams generated while performing masking using UE ID of a UE to which it desires to transmit HS-SCCH, and cyclic-shifts streams based on UE ID of each UE, the UE determines reliability of Viterbi decoding, after performing the Viterbi decoding.

Therefore, in the operation performed according to the second embodiment of the present invention, when the UE uses the second embodiment of the present invention as shown in FIG. 15 (see 1510) in the process of determining reliability of Viterbi decoding, the UE contributes to an increase in an FQM difference (difference between 1500a and 1510) between the case where the UE receives HS-SCCH transmitted to the UE itself and the case where the UE receives HS-SCCH transmitted to another UE, compared to when it uses the first embodiment of the present invention (see 1500). That is, in the first embodiment of the present invention, because FQM values of both the UE1 1004 and the UE2 1006 are less than the threshold, there is a high probability that the UE2 1006 will attempt demodulation on control information allocated to the UE1 1004, and data. However, the second embodiment of the present invention allows the UE2 1006 to have an FQM value greater than the threshold 1204 as shown by reference numeral 1505, contributing to a reduction in the probability that the UE2 1006 will attempt demodulation on the control information not allocated to itself, and data.

As is apparent from the foregoing description, in the mobile communication system supporting high-speed packet data transmission according to the present invention, the base station shifts control information and UE ID-based streams using UE ID of the UE scheduled to receive packet data, before transmission, so that the UE can improve reliability of the decoder after performing decoding on the streams, thereby contributing to a reduction in reception error of the control channel.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for encoding a control channel to transmit high-speed packet data in a base station of a high-speed packet data communication system, the method comprising:
encoding a User Equipment Identifier (UE ID) of a UE that will receive the high-speed packet data, and rate-matching the encoded UE ID to generate a first stream;
generating an offset value for cyclic-shifting the first stream, using the UE ID;
encoding control information that the UE needs to receive the high-speed packet data, and rate-matching the encoded control information to generate a second stream;
cyclic-shifting each of the first stream and the second stream by the offset value; and
masking the cyclic-shifted second stream with the cyclic-shifted first stream before transmission.

2. The method of claim 1, wherein masking the cyclic-shifted second stream with the cyclic-shifted first stream comprises:
eXclusive ORing (XORing) the cyclic-shifted first stream and the cyclic-shifted second stream before transmission.

3. The method of claim 1, wherein the offset value is obtained by performing modulo operation on the UE ID in a size of the second stream.

4. A method for decoding a control channel to receive high-speed packet data in a User Equipment (UE) of a high-speed packet data communication system, the method comprising:
receiving a stream including control information necessary for receiving the high-speed packet data from a base station;
generating a first stream using a UE Identifier (UE ID) of the UE to unmask the received stream;
generating an offset value for cyclic-shifting the first stream, using the UE ID;
cyclic-shifting the first stream by the offset value;
unmasking the received stream with the cyclic-shifted first stream to generate a second stream;
cyclic-shifting the second stream by the offset value to generate a third stream; and
decoding the third stream to acquire control information.

5. The method of claim 4, wherein the offset value is obtained by performing modulo operation on the UE ID in a size of the first stream.

6. The method of claim 4, wherein unmasking the received stream with the cyclic-shifted first stream to generate a second stream comprises:
eXclusive ORing (XORing) the first stream and the received stream.

7. An apparatus for encoding a control channel to transmit high-speed packet data in a base station of a high-speed packet data communication system, the apparatus comprising:
a masking stream generator for encoding a User Equipment Identifier (UE ID) of a UE that will receive the high-speed packet data, rate-matching the encoded UE ID to generate a first stream, and generating an offset value for cyclic-shifting the first stream; and
a transmission stage for multiplexing and coding control information that the UE needs to receive the high-speed packet data, rate-matching the coded control information to generate a second stream, cyclic-shifting each of the first stream and the second stream by the offset value, and masking the cyclic-shifted second stream with the cyclic-shifted first stream before transmission.

8. The apparatus of claim 7, wherein the offset value is obtained by performing modulo operation on the UE ID in a size of the second stream.

9. The apparatus of claim 7, wherein the transmission stage comprises:
a first shifter for cyclic-shifting the first stream generated by the masking stream generator by the offset value;
a second shifter for cyclic-shifting the second stream by the offset value; and
an exclusive OR (XOR) unit for XORing the cyclic-shifted first stream and the cyclic-shifted second stream.

10. An apparatus for decoding a control channel to receive high-speed packet data in a User Equipment (UE) of a high-speed packet data communication system, the apparatus comprising:
a masking stream generator for encoding and rate matching a UE Identifier (UE ID) of the UE to generate a first stream, and generating an offset value for cyclic-shifting the first stream; and
a reception stage for receiving a stream including control information necessary for receiving the high-speed packet data from a base station, cyclic-shifting the first stream generated by the masking stream generator by the offset value, unmasking the received stream with the cyclic-shifted first stream to generate a second stream, cyclic-shifting the second stream by the offset value to generate a third stream, and decoding the third stream to acquire control information.

11. The apparatus of claim 10, wherein the offset value is obtained by performing modulo operation on the UE ID in a size of the first stream.

12. The apparatus of claim 10, wherein the reception stage comprises:
a first shifter for cyclic-shifting the first stream generated by the masking stream generator by the offset value;
an exclusive OR (XOR) unit for XORing the received stream and the first stream cyclic-shifted by the first shifter; and
a second shifter for cyclic-shifting the stream XORed by the XOR unit by the offset value.
